(19) United States
(12) Patent Application Publication
(10) Pub. No.: US 2015/0036622 A1
(43) Pub. Date: Feb. 5, 2015

(54) UPLINK PILOT CHANNEL TRANSMISSION TO REDUCE LATENCY OF CIRCUIT SWITCHED FALL BACK

(71) Applicant: QUALCOMM Incorporated, San Diego, CA (US)

(72) Inventors: Ming YANG, San Diego, CA (US); Tom Chin, San Diego, CA (US); Guangming SHI, San Diego, CA (US)

(21) Appl. No.: 14/446,241

(22) Filed: Jul. 29, 2014

Related U.S. Application Data
(60) Provisional application No. 61/862,346, filed on Aug. 5, 2013.

(51) Int. Cl. H04W 74/00

(52) U.S. Cl. CPC H04W 74/002
USPC 370/329

(57) ABSTRACT

A method of wireless communication includes initiating a specific call type and transmitting a first random access preamble via a first random access preamble channel when initiating the specific call type. The method also includes transmitting a second random access preamble via a second random access preamble channel when initiating the specific call type. The second random access preamble is transmitted without waiting for a response to the transmitted first random access preamble

### CROSS REFERENCE TO RELATED APPLICATIONS

The present application claims the benefit of U.S. Provisional Patent Application No. 61/862,346, filed on Aug. 5, 2013, in the names of Ming Yang et al., the disclosure of which is expressly incorporated by reference herein in its entirety.

### TECHNICAL FIELD

Aspects of the present disclosure relate generally to wireless communication systems, and more particularly, to reducing the latency of transitioning from one radio access technology (RAT) to another RAT when initiating a specific call type.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is disclosed. The method includes initiating a specific call type and transmitting a first random access preamble via a first random access preamble channel when initiating the specific call type. The method also includes transmitting a second random access preamble via a second random access preamble channel when initiating the specific call type. The second random access preamble is transmitted without waiting for a response to the transmitted first random access preamble.

Another aspect of the present disclosure is directed to an apparatus including means for initiating a specific call type and means for transmitting a first random access preamble via a first random access preamble channel when initiating the specific call type. The apparatus also includes means for transmitting a second random access preamble via a second random access preamble channel when initiating the specific call type. The second random access preamble is transmitted without waiting for a response to the transmitted first random access preamble.

In another aspect of the present disclosure, a computer program product for wireless communications in a wireless network is disclosed. The computer readable medium has non-transitory program code recorded thereon which, when executed by the processor(s), causes the processor(s) to perform operations of initiating a specific call type and transmitting a first random access preamble via a first random access preamble channel when initiating the specific call type. The program code also causes the processor(s) to transmit a second random access preamble via a second random access preamble channel when initiating the specific call type. The second random access preamble is transmitted without waiting for a response to the transmitted first random access preamble.

Another aspect of the present disclosure is directed to an apparatus for a wireless communication having a memory and at least one processor coupled to the memory. The processor(s) is configured to initiate a specific call type and transmit a first random access preamble via a first random access preamble channel when initiating the specific call type. The processor(s) is also configured to transmit a second random access preamble via a second random access preamble channel when initiating the specific call type. The second random access preamble is transmitted without waiting for a response to the transmitted first random access preamble.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates a call flow of a circuit switched fall back procedure.

FIG. 6 illustrates a call flow of a conventional random access process.

FIG. 7 illustrates a call flow of another conventional random access process.

FIG. 8 illustrates a call flow of a random access process according to aspects of the present disclosure.

FIG. 9 is a block diagram illustrating a wireless communication method for transmission of preambles according to aspects of the present disclosure.

FIG. 10 is a block diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

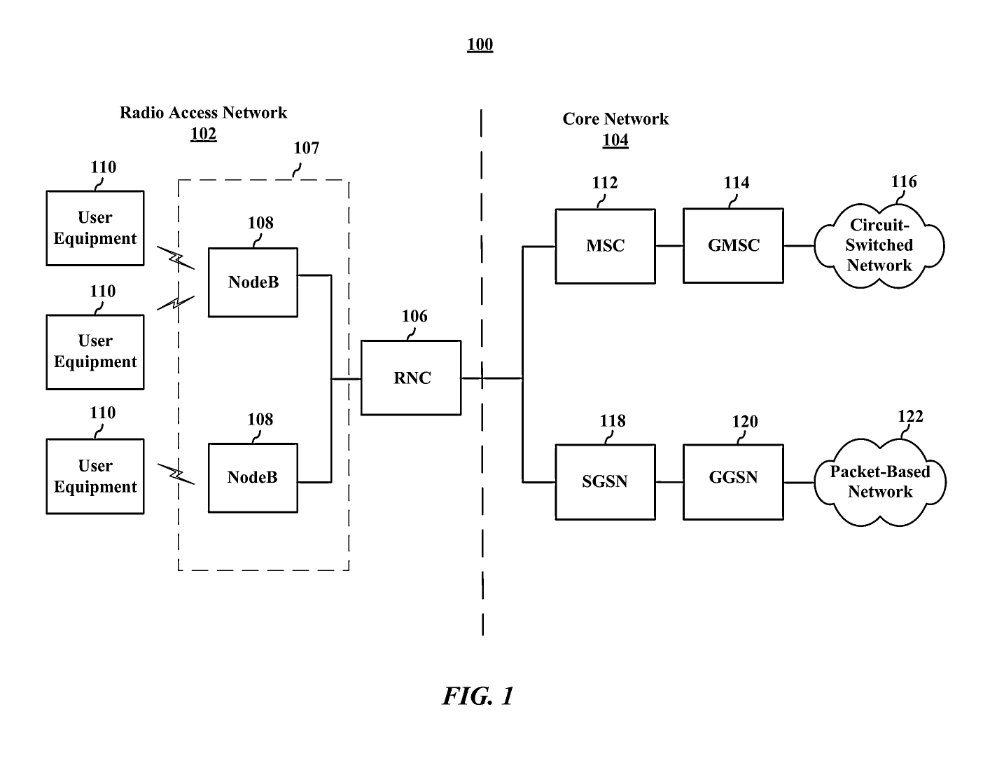

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

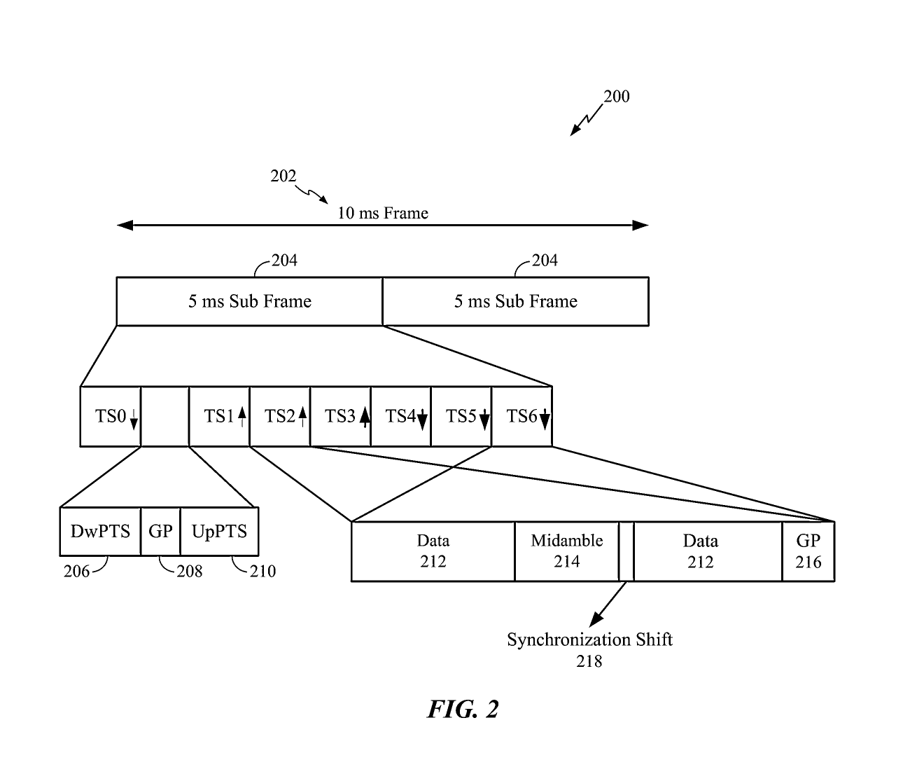

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS 1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

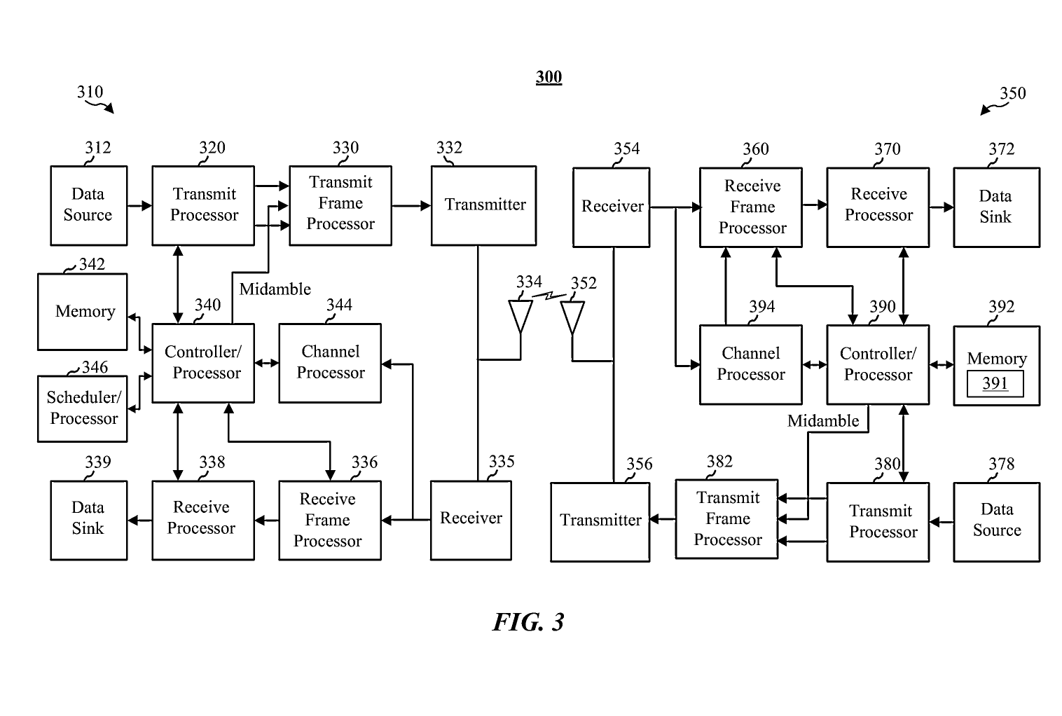

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a preamble transmission module 391, which when executed by the controller/processor 390, configures the UE 350 to transmit multiple random access preambles via the same random access preamble channel or consecutive random access preamble channels based on aspects of the present disclosure. A scheduler/processor 346 at the node B 310 may allocate resources to the UEs and schedule downlink and/or uplink transmissions for the UEs.

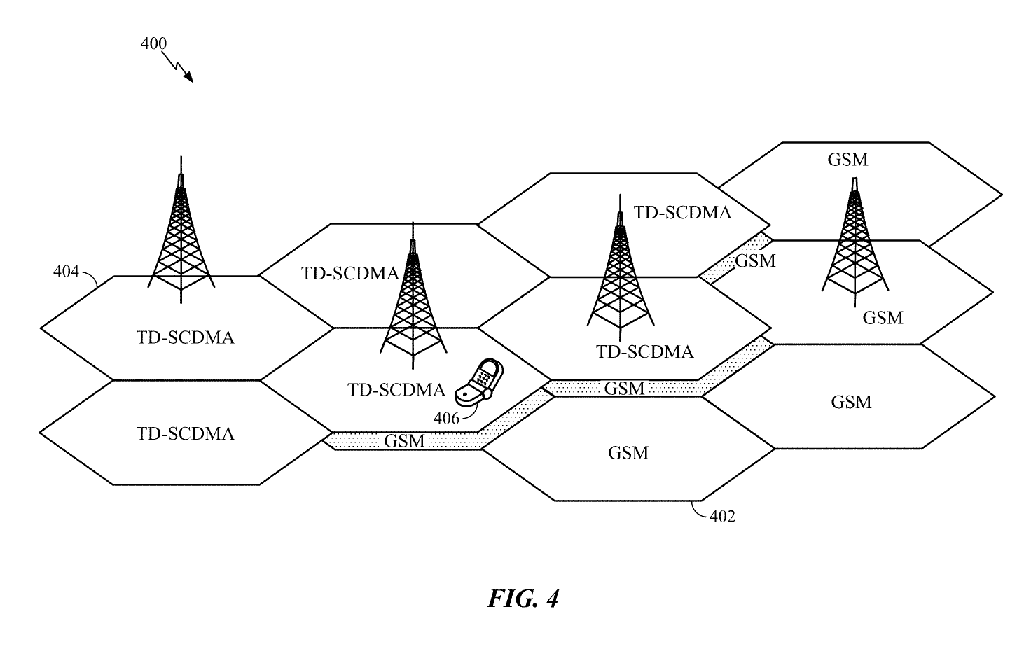

FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Other radio access technologies, such as a wireless local area network (WLAN) or WiFi may also be accessed by a user equipment (UE) in addition to cellular networks such as TD-SCDMA or GSM. For the UE to determine nearby WiFi access points (APs), the UE scans available WiFi channels to identify/detect if any WiFi networks exist in the vicinity of the UE. In one configuration, the UE may use TD-SCDMA reception/transmission gaps to switch to the WiFi network to scan the WiFi channels.

### Uplink Pilot Channel Transmission to Reduce Latency of Circuit-Switched Fall Back

Aspects of the disclosure are directed to reducing latency of a circuit-switched fall back (CSFB) procedure from one RAT, such as LTE, to another RAT, such as UMTS (e.g., time division-synchronous code division multiple access (TD-SCDMA)), or GSM.

In some cases, redirection from one RAT to another RAT may be for load balancing or for a circuit-switched fall back procedure. For example, the redirection may be from a first RAT, such as LTE, to a second RAT, such as universal mobile telecommunications system-frequency division duplexing (UMTS FDD), universal mobile telecommunications system-time division duplexing (UMTS TDD), or global system for mobile communications (GSM).

Circuit-switched fall back is for a multimode UE to provide circuit-switched (CS) voice services when the multimode UE is camped or associated with a packet-switched (PS) RAT. Multimode UEs refer to UEs that may communicate on a first RAT while connected to a second RAT. In one configuration, the first RAT is 3G/2G and the second RAT is LTE, or vice versa.

In one example, a mobile-originated (MO) circuit-switched voice call is initiated at a UE when the UE is camped on a packet-switched RAT, such as LTE. In response to initiating the mobile-originated circuit-switched voice call, the UE is moved to a circuit-switched RAT, such as 3G/2G, for a circuit-switched voice call setup. As another example, a UE may be paged for a mobile-terminated (MT) voice call when the UE is camped on a packet-switched RAT, such as LTE. In response to receiving the page for the mobile-terminated voice call, the UE is moved to a circuit-switched RAT, such as 3G/2G, for a circuit-switched voice call setup.

That is, in some UEs data transmissions are specified for a packet-switched RAT, such as LTE, and voice transmissions are specified by a circuit-switched RAT, such as 3G/2G. Thus, as previously discussed, when a UE is associated with a packet-switched RAT, a circuit-switched fall back procedure is specified when a voice transmissions is originated at the UE and/or when the UE is paged for a voice transmission.

Although circuit-switched fall back may be specified as a single radio voice solutions for a UE associated with a packet-switched RAT, the circuit-switched fall back procedure may increase the time specified for a call setup. That is, call setup latency may be experienced for a conventional circuit-switched fall back. Thus, it is desirable to reduce the call setup latency for circuit-switched fall back. Conventional networks may reduce the call setup latency by reducing the time used to collect system information block (SIB).

Additionally, for improved use of a physical channel, such as a dedicated physical channel (DPCH), a time division duplexing network, such as a TD-SCDMA network, may specify time division multiplexing on the physical channel. The physical channel may also be referred to as an associative physical channel, such as an associative DPCH (a-DPCH).

Aspects of the present disclosure are directed to reducing the time for random access procedure during a circuit-switched fall back procedure from a first RAT to a second RAT.

In a conventional network, the UE selects an uplink pilot channel (UpPCH) sub-channel and a synchronous uplink (SYNC-UL) sequence from the uplink pilot sub-channels and synchronous uplink sequences available for a given access service class (ASC). The UE transmits a preamble for the synchronous uplink sequences via the uplink pilot sub-channel. The preamble may be transmitted at the UE's signature transmission power. After transmitting a preamble, the UE waits to receive an acknowledgement (ACK) or negative acknowledgement (NACK) via a channel, such as a fast physical access channel (FPACH).

In some cases, the base station may not receive a preamble because of a collision or because the UE is in a low propagation environment. When the base station does not receive the preamble, the UE does not receive a response to the transmitted preamble from the base station. Furthermore, when the UE fails to receive a response from the base station, the UE adjusts a transmission time and/or a transmission power level based on a new measurement and transmits another preamble after a delay period.

A wait window is specified to receive a response to a transmitted preamble. Moreover, the UE subsequently transmits a second preamble for a synchronous uplink sequence when a response is not received during the wait window. For some RATs, such as TD-SCDMA, a specific time period is set for the wait window. In other RATs, such as wideband code division multiple access (W-CDMA), or LTE, the time period specified for the wait window is shorter than the time period specified for other RATs, such as TD-SCDMA.

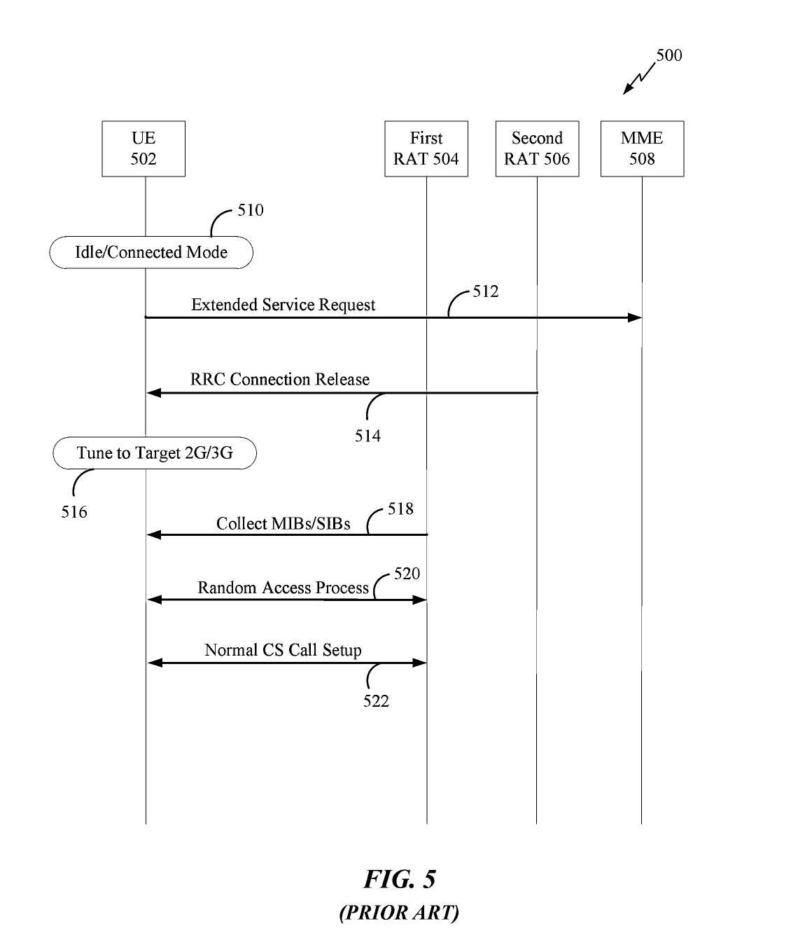

FIG. 5 illustrates a call flow 500 of a circuit switched fall back procedure. As shown in FIG. 5, the network includes a UE 502, a first RAT 504, such as a TD-SCDMA RAT, a second RAT 506, such as an LTE RAT, and a mobility management entity (MME) 508. At time 510, the UE 502 is in an idle mode or a connected mode with the second RAT 506. Furthermore, at time 512, the UE 502 transmits an extended service request to the MME 508. In one configuration, the extended service request is an indicator for a mobile-originated or mobile-terminated circuit-switched voice call. That is, the extended service request transmitted at time 512 initializes a circuit-switched fall back procedure when a circuit-switched call is initiated.

In response to the extended service request transmitted at time 512, the second RAT 506 transmits a radio resource control (RRC) connection release message to the UE 502 at time 514. In some cases, the RRC connection release message may not include 2G and/or 3G redirection information. Furthermore, the RRC connection release message may include a fast return flag set to true and may also include cell quality information. Although the term “quality” is used, signal “strength” is also contemplated.

After receiving the RRC connection release message, the UE 502 tunes to a target 2G/3G network, such as the first RAT 504, at time 516. Furthermore, at time 518, the first RAT 504 transmits a request to the UE 502 to collect the master information blocks (MIBs) and the system information blocks (SIBs). Additionally, at time 520, a random access process occurs. Finally, at time 522, a circuit-switched (CS) call setup is initialized.

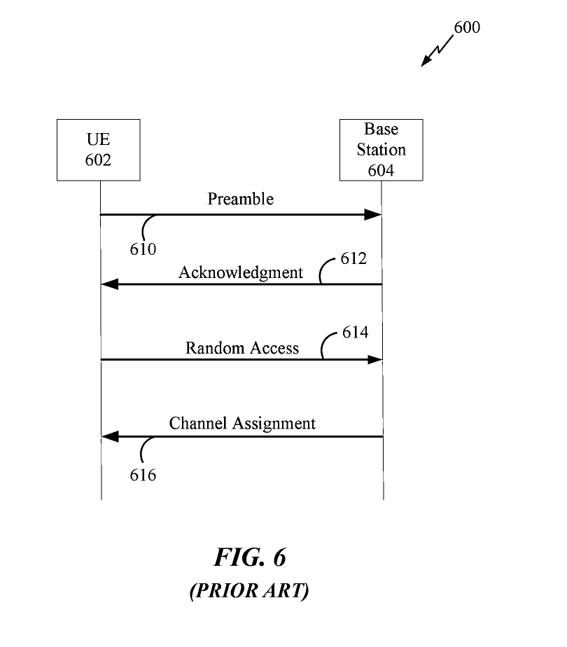

FIG. 6 illustrates a call flow 600 of conventional random access process. As shown in FIG. 6, a UE 602 is associated with a base station 604. At time 610, the UE 602 transmits one of N synchronization uplink (SYNC-UL) sequences (e.g., preamble) to the base station 604. In one configuration, N is eight (8). Additionally, the preamble may be transmitted via an uplink pilot channel, such as the UpPCH. In response to receiving the preamble, the base station 604 transmits, at time 612, an acknowledgment message in addition to power and timing adjustment commands. The acknowledgment message, power adjustment command, and timing adjustment command may be transmitted via a physical access channel, such as the fast physical access channel (FPACH).

At time 614, the UE 602 uses the codes associated with the fast physical access channel in addition to the power and timing adjustment commands to transmit a random access request to the base station 604. The random access request may be transmitted via a random access channel, such as the physical random access channel (PRACH). In response to receiving the random access request, the base station 604 determines channel assignment information based on carriers, codes, time slots, and/or midambles. At time 616, the base station 604 transmits the channel assignment information to the UE 602 via a common control channel, such as a secondary common control physical channel (S-CCPCH), or an access channel, such as the forward access channel (FACH).

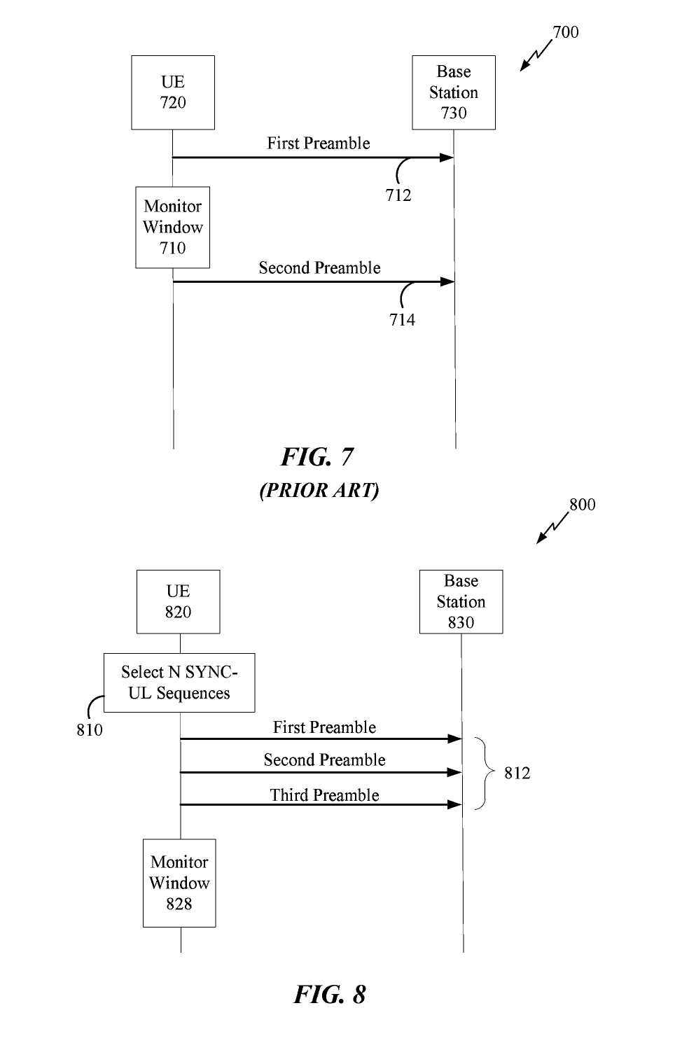

FIG. 7 illustrates a timing diagram 700 of conventional preamble transmission during a random access process. The UE 720 transmits a first preamble for a synchronization uplink sequence, at time 712, to a base station 730 and monitors a physical access channel for a response to transmission of the first preamble. A monitor window 710 is specified for the UE 720 to monitor the physical access channel for a response. The monitor window 710 may be a combination of a random access monitor window and a back off window. In some cases, if a response is not received before a time period specified for the monitor window 710 elapses, the UE 720 transmits a second preamble at time 714. The second preamble may be the same as the first preamble or may be a different preamble. Furthermore, the second preamble may have a different transmission power, such as a higher transmission power, in comparison to the first preamble.

As previously discussed, during the monitor window 710, the UE 720 monitors a physical access channel for a response from the base station 730. In one case, the UE 720 initiates a voice call if a response is received during the monitor window 710. Alternatively, if a response is not received before a time period specified for the monitor window 710 elapses, the UE 720 transmits another preamble or retransmits the previous preamble. In a conventional network, the UE 720 transmits one preamble at each time 712, 714.

Although not shown in FIG. 7, after transmitting the second preamble at time 714, another monitor window is specified. In this example, if a response to the second preamble is not received during the monitor window, the UE may transmit a third preamble. The third preamble may be the same as the second preamble and/or the first preamble or may be different from the second preamble and/or the first preamble. The first time 712 and the second time 714 each represent a timing instance, such as a subframe. The preambles may be transmitted via the same sub-channel, such as a random access channel, or an uplink pilot channel.

According to an aspect of the present disclosure, to improve the random access process, when a UE initiates a transition of a specific call type from a first RAT to a second RAT due to a circuit-switched fall back procedure, the UE select N synchronous uplink sequence(s).

Furthermore, the UE may transmit the selected synchronous uplink sequences (e.g., preambles) via N consecutive uplink pilot sub-channels or the same uplink pilot sub-channel. The preambles may be transmitted with an increasing power level for each sub-channel or with the same power level for each sub-channel. In this configuration, the UE monitors a physical access channel, such as the fast physical access channel, after the preamble transmissions. Furthermore, in this configuration, when one of the preambles is acknowledged by the base station via the physical access channel, the UE uses the uplink time and the power information received via the physical access channel to access the second RAT via a random access channel, such as the physical random access channel. In one configuration, the second RAT is TD-SCDMA and the first RAT is LTE.

FIG. 8 illustrates a timing diagram 800 of a random access process in accordance with an aspect of the present disclosure. In one configuration, as shown in FIG. 8, at time 810, the UE 820 selects N synchronization uplink sequences for transmission. Furthermore, at a time 812, the UE 820 transmits multiple preambles for the selected N synchronization uplink sequences to the base station 830. In one configuration, the preambles are transmitted via the same uplink sub-channel. Additionally, or alternatively, multiple uplink sub-channels may be selected so that each preamble is transmitted via one of N consecutive uplink sub-channels.

In this configuration, the time 812 represents one timing instance, such as a subframe. In one configuration, the sub-channels are random access preamble channels, such as a physical random access channel (PRACH). In another configuration, the preambles are transmitted via one or more uplink pilot channels.

In one configuration, a monitor window 828 is initialized after the preambles are transmitted by the UE 820. In this configuration, the UE 820 initiates a voice call if a response for one or more of the transmitted preambles is received during the monitor window 828. Specifically, the UE initiates the voice call using the uplink time information and power information included in the received response. Alternatively, if a response is not received during the monitor window 828, the UE 820 may retransmit (not shown) N preambles after the time period specified for the monitor window 828 elapses.

Although FIG. 8 illustrates three preambles being transmitted, aspects of the present disclosure are not limited to transmitting three preambles via a same sub-channel or consecutive sub-channels. Of course, more or fewer preambles may be transmitted as desired.

In one configuration, the preambles are all the same preamble. In other configurations, the preambles are all different, or some are the same and some are different. For example, if three preambles are selected for transmission, two of the preambles may be the same and the remaining preamble may be different. In one configuration, each preamble is transmitted with a different transmission power level. Alternatively, the preambles may be transmitted with the same transmission power level.

That is, in one configuration, the selected preambles are the same and the selected preambles are all transmitted at the same power level. In another configuration, each selected preamble is different and each selected preamble is transmitted with a different power level. In still another configuration, each of the selected preambles is different and all the selected preambles are transmitted with the same power levels. In still yet another configuration, the selected preambles are the same and each of the selected preambles is transmitted with a different power level.

According to an aspect of the present disclosure, multiple preambles are transmitted without waiting for a response from a base station. That is, multiple preambles may be transmitted at a time instance and a response may be received for one or more of the preambles after that time instance. As previously discussed, the time instance may be one or more subframes on a same sub-channel and/or one or more subframes of consecutive sub-channels.

Based on aspects of the present disclosure, the multiple preamble transmissions improve the likelihood of a base station receiving one or more of the preambles. That is, the latency of a circuit-switched fall back call may be reduced as a result of the simultaneous transmission of multiple preambles. Aspects of the present disclosure are directed to a circuit switched fall back, still, aspects of the present disclosure are not limited to circuit switched fall backs and other network procedures are contemplated, such as emergency call procedures.

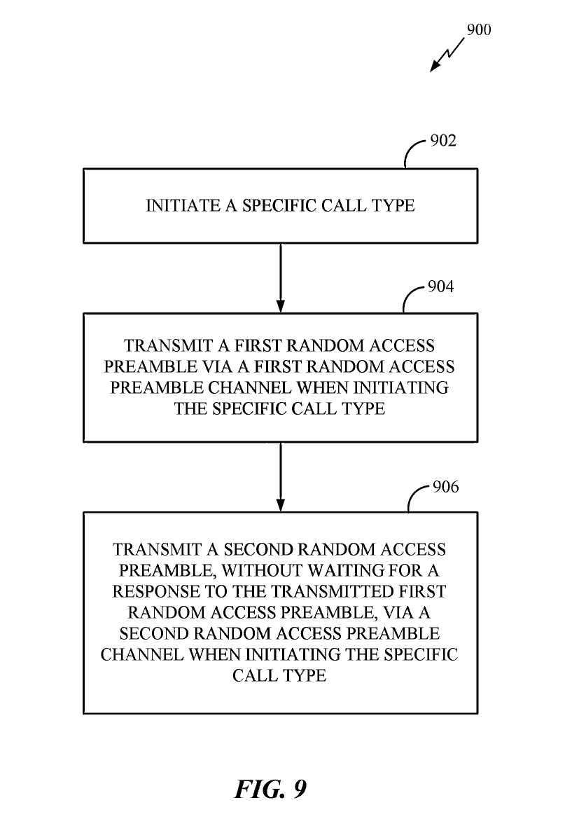

FIG. 9 is a block diagram illustrating a wireless communication method 900 for transmission of preambles according to aspects of the present disclosure. In block 902, the UE initiates a specific call type. In one configuration, the specific call type is a circuit-switched fall back call. In another configuration, the specific call type is an emergency call. In block 904, in response to initiating the specific call type, the UE transmits a first random access preamble via a first random access preamble channel. Additionally, in block 906, the UE transmits a second random access preamble via a second random access preamble channel without waiting for a response to the transmitted first random access preamble. As previously discussed, the first random access preamble channel and the second random access preamble channel may be the same channel or may be different consecutive channels.

In another configuration, the first random access preamble is also transmitted on the second random access preamble channel and the second random access preamble is also transmitted on the first random access preamble channel.

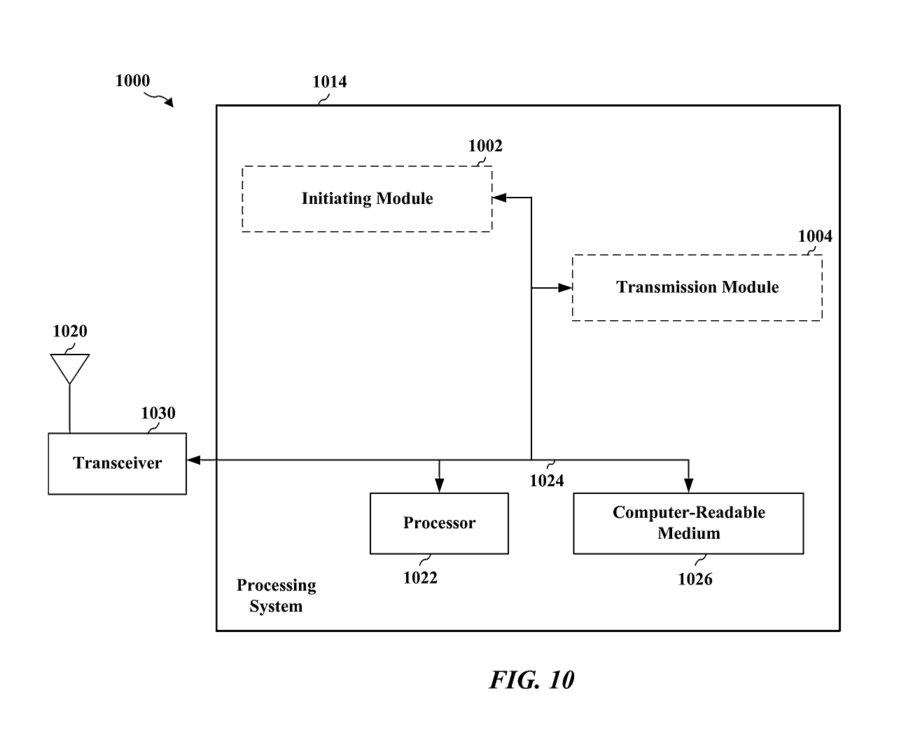

FIG. 10 is a diagram illustrating an example of a hardware implementation for an apparatus 1000 employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022, the initiating module 1002, the transmission module 1004, and the computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes an initiating module 1002 for initiating a specific call type. The processing system 1014 also includes a transmission module 1004 for transmitting a first random access preamble via a first random access preamble channel. The transmission module 1004 may also be configured to transmit a second random access preamble via a second random access preamble channel. FIG. 10 illustrates one module for the transmission module 1004. Still, aspects of the present disclosure are also contemplated for multiple transmission modules 1004 for each random access preamble transmission. The modules may be software modules running in the processor 1022, resident/stored in the computer-readable medium 1026, one or more hardware modules coupled to the processor 1022, or some combination thereof. The processing system 1014 may be a component of the UE 350 and may include the memory 392, and/or the controller/processor 390.

In one configuration, an apparatus such as an UE 350 is configured for wireless communication including means for initiating. In one aspect, the above means may be the antennas 352, the transmitter 356, the transmit processor 380, the controller/processor 390, the memory 392, the preamble transmission module 391, the initiating module 1002, the processor 1022, and/or the processing system 1014 configured to perform the functions recited by the aforementioned means. In another aspect, the aforementioned means may be any module or any apparatus configured to perform the functions recited by the aforementioned means.

In one configuration, the apparatus configured for wireless communication also includes means for transmitting. In one aspect, the above means may be the antennas 352, the transmitter 356, the transmit processor 380, the controller/processor 390, the memory 392, the preamble transmission module 391, the transmission module 1004, the processor 1022, and/or the processing system 1014 configured to perform the functions recited by the aforementioned means. In another aspect, the aforementioned means may be any module or any apparatus configured to perform the functions recited by the aforementioned means.

Several aspects of a telecommunications system has been presented with reference to TD-SCDMA and LTE systems. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
initiating a specific call type;
transmitting a first random access preamble via a first random access preamble channel when initiating the specific call type; and
transmitting a second random access preamble, without waiting for a response to the transmitted first random access preamble, via a second random access preamble channel when initiating the specific call type.

2. The method of claim 1, in which the first random access preamble channel is a same channel as the second random access preamble channel.

3. The method of claim 1, in which the second random access preamble channel is different from the first random access preamble and is consecutive to the first random access preamble channel.

4. The method of claim 1, in which the first random access preamble is a same preamble as the second random access preamble.

5. The method of claim 1, in which the first random access preamble and the second random access preamble are transmitted at different power levels.

6. The method of claim 1, in which the first random access preamble and the second random access preamble are transmitted at a same power level.

7. The method of claim 1, further comprising transmitting a connection request in response to receiving an acknowledgment for at least one of the first random access preamble, the second random access preamble, or a combination thereof.

8. The method of claim 1, in which the specific call type is a circuit switched fall back (CSFB) call.

9. The method of claim 1, in which the specific call type is an emergency call.

10. An apparatus for wireless communication, comprising:
means for initiating a specific call type;
means for transmitting a first random access preamble via a first random access preamble channel when initiating the specific call type; and
means for transmitting a second random access preamble, without waiting for a response to the transmitted first random access preamble, via a second random access preamble channel when initiating the specific call type.

11. The apparatus of claim 10, in which the second random access preamble channel is different from the first random access preamble and is consecutive to the first random access preamble channel.

12. The apparatus of claim 10, in which the first random access preamble is a same preamble as the second random access preamble.

13. The apparatus of claim 10, in which the first random access preamble and the second random access preamble are transmitted at different power levels.

14. The apparatus of claim 10, further comprising means for transmitting a connection request in response to receiving an acknowledgment for at least one of the first random access preamble, the second random access preamble, or a combination thereof.

15. The apparatus of claim 10, in which the specific call type is a circuit switched fall back (CSFB) call.

16. A computer program product for wireless communication in a wireless network, comprising:
a non-transitory computer-readable medium having non-transitory program code recorded thereon, the program code comprising:
program code to initiate a specific call type;
program code to transmit a first random access preamble via a first random access preamble channel when initiating the specific call type; and
program code to transmit a second random access preamble, without waiting for a response to the transmitted first random access preamble, via a second random access preamble channel when initiating the specific call type.

17. The computer program product of claim 16, in which the second random access preamble channel is different from the first random access preamble and is consecutive to the first random access preamble channel.

18. The computer program product of claim 16, in which the first random access preamble is a same preamble as the second random access preamble.

19. The computer program product of claim 16, in which the first random access preamble and the second random access preamble are transmitted at different power levels.

20. The computer program product of claim 16, in which the program code further comprises program code to transmit a connection request in response to receiving an acknowledgment for at least one of the first random access preamble, the second random access preamble, or a combination thereof.

21. The computer program product of claim 16, in which the specific call type is a circuit switched fall back (CSFB) call.

22. An apparatus for wireless communication, comprising:
a memory; and
at least one processor coupled to the memory, the at least one processor being configured:
to initiate a specific call type;
to transmit a first random access preamble via a first random access preamble channel when initiating the specific call type; and
to transmit a second random access preamble, without waiting for a response to the transmitted first random access preamble, via a second random access preamble channel when initiating the specific call type.

23. The apparatus of claim 22, in which the first random access preamble channel is a same channel as the second random access preamble channel.

24. The apparatus of claim 22, in which the second random access preamble channel is different from the first random access preamble and is consecutive to the first random access preamble channel.

25. The apparatus of claim 22, in which the first random access preamble is a same preamble as the second random access preamble.

26. The apparatus of claim 22, in which the first random access preamble and the second random access preamble are transmitted at different power levels.

27. The apparatus of claim 22, in which the first random access preamble and the second random access preamble are transmitted at a same power level.

28. The apparatus of claim 22, in which the at least one processor is further configured to transmit a connection request in response to receiving an acknowledgment for at least one of the first random access preamble, the second random access preamble, or a combination thereof.

29. The apparatus of claim 22, in which the specific call type is a circuit switched fall back (CSFB) call.

30. The apparatus of claim 22, in which the specific call type is an emergency call.
